(19) United States
(12) Patent Application Publication
(10) Pub. No.: US 2017/0186243 A1
(43) Pub. Date: Jun. 29, 2017

(54) Video Image Processing Method and Electronic Device Based on the Virtual Reality

(71) Applicants: Le Holdings (Beijing) Co., Ltd., Beijing (CN); Le Shi Zhi Xin Electronic Technology (Tianjin) Limited, Tianjin (CN)

(72) Inventor: Xuan Shi, Tianjin (CN)

(21) Appl. No.: 15/247,190

(22) Filed: Aug. 25, 2016

Related U.S. Application Data
(63) Continuation of application No. PCT/CN2016/088449, filed on Jul. 4, 2016.

(30) Foreign Application Priority Data
Dec. 28, 2015 (CN) 2015110179351

(51) Int. Cl. G06T 19/20; G06T 19/00; H04N 19/187; G06T 1/20; H04N 19/44; G06T 15/04; H04N 1/60

(52) U.S. Cl. CPC G06T 19/20; G06T 15/04; G06T 19/006; H04N 1/6027; G06T 1/20; H04N 19/44; H04N 19/187; G06T 2219/2016

(57) ABSTRACT

Disclosed are a video image processing method and electronic device based on virtual reality. The method comprises: determining a curtain resolution and a monocular rendering resolution in a virtual scene; determining a scaling according to the curtain resolution and the monocular rendering resolution; acquiring a video frame of decoded video data, and scaling the video frame according to the scaling; and transmitting the scaled video frame to a three-dimensional image processor, and carrying out texture mapping according to the scaled video frame and the virtual scene. According to the method, a professional two-dimensional image engine preset in a chip of a chip plant is used for scaling the video frame at first after decoding, and then the scaled video frame is transmitted to a three-dimensional image processor for displaying as a texture, so that the purpose of saving three-dimensional graphic processing resources is achieved.

### CROSS REFERENCE TO RELATED APPLICATIONS

This application is a continuation of International Application No. PCT/CN2016/088449, filed on Jul. 4, 2016, which is based upon and claims priority to Chinese Patent Application No. 201511017935.1, filed on Dec. 28, 2015, and titled “Video Image Processing Method and Device Based on Virtual Reality”, the entire contents of which are incorporated herein by reference.

### TECHNICAL FIELD

The disclosure relates to the field of virtual reality technology, and particularly relates to a video image processing method and electronic device based on the virtual reality technology.

### BACKGROUD

The virtual reality (VR) is a computer stimulation system capable of creating and experiencing a virtual world, which makes use of a computer to generate a simulation environment that is a system stimulation of an interactive three-dimensional dynamic vision of multi-source information fusion and entity behaviors, and the virtual reality can make user immerse in this environment. The principle of stereo imaging is to enable left and right eyes to see different contents, so that the two eyes have a parallax since a three-dimensional illusion can be formed in the brain of a person. Specifically, as 3D equipment provides a left eye image and a right eye image, respectively, the left eye of a user sees an image corresponding to the left eye, and the right eye of the user sees an image corresponding to the right eye, so that a three-dimensional image is formed in the brain of the user. The virtual reality has experienced from being unknown to the public to being popular recently, and the realization of the virtual reality of non-PCs at present is still based on an Android mobile phone as a carrier.

In the existing application of the virtual reality based on an Android system mobile phone, the rendering is mainly realized through a 3D engine by using openGL ES, and is finally separated into left eye display and right eye display by using a coordinate system, and under a condition that a conventional 2D/3D video exists in a scene, each frame of the video is taken as a texture mapped at a screen position in a panorama.

In the process of implementing the disclosure, the inventor finds that: in the existing solution, when a video is played in a virtual panorama, the decoded data are rendered as a texture by only using a graphics processor, but under the condition that the resolution of the decoded video is very large, each frame of the video needs to be scaled by the graphics processor, which wastes graphics processor resources.

### SUMMARY

In order to overcome the defect of the waste of the graphics processor resources in the prior art, according to one aspect of the disclosure, the disclosure provides a video image processing method and electronic device based on virtual reality.

In the first place, a video image processing method based on virtual reality, provided by the embodiments of the disclosure, comprises:

determining a curtain resolution and a monocular rendering resolution in a virtual scene, the curtain resolution in the virtual scene and the video resolution in monocular display being consistent in size;

determining a scaling factor according to the curtain resolution and the monocular rendering resolution;

acquiring a video frame of decoded video data, and scaling the video frame according to the scaling factor; and

sending the scaled video frame to a three-dimensional image processor, and executing texture mapping according to the scaled video frame and the virtual scene.

In the above technical solution, executing texture mapping according to the scaled video frame and the virtual scene comprises:

synthesizing the scaled video frame and the corresponding virtual scene, and placing the scaled video frame to a corresponding position in the virtual scene as a texture; and

pushing a synthesized rendering video to a display screen.

In the above technical solution, when the format of the video frame of the decoded video data is YUV, scaling the video frame according to the scaling factor comprises:

converting the video frame with a YUV format into a video frame with an RGB format; and

scaling the video frame with the RGB format according to the scaling factor.

In the above technical solution, scaling the video frame according to the scaling factor comprises:

calling a two-dimensional image processor and/or decoder to scale the video frame according to the scaling factor.

In the above technical solution, the monocular rendering resolution is the same as a screen resolution.

In the second place, the embodiment of the disclosure further provides a non-transitory computer-readable storage medium storing executable instructions that, when executed by an electronic device, cause the electronic device to executing any of the above video image processing method based on the virtual reality technology.

In the third place, the embodiment of the disclosure further provides an electronic device, comprising: at least one processor; and a memory communicably connected with the at least one processor for storing instructions executable by the at least one processor, wherein execution of the instructions by the at least one processor causes the at least one processor to executing any of the above video image processing method based on the virtual reality technology.

For the video image processing method and device based on virtual reality, provided by the embodiment of the disclosure, a professional two-dimensional image engine preset in a chip of a chip plant is used in the method to scale the video frame at first after decoding, and then the scaled video frame is transmitted to a three-dimensional image processor for displaying as a texture, so that the purpose of saving three-dimensional graphic processing resources is achieved. When the format of the video frame of the decoded video data is YUV, the video frame is continuously converted into an RGB format through two-dimensional image processing, thereby further saving the three-dimensional graphic processing resources.

Other features and advantages of the disclosure will be stated in the following description, and partially become apparent from the description, or will be understood by implementation of the disclosure. The purpose and other advantages of the disclosure can be achieved and obtained through a structure specified in the written description, claims, and accompanying drawings.

Hereinafter, the technical solution of the disclosure is further described in details through the accompanying drawings and embodiments.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram of a video image processing method based on virtual reality in the embodiment of the disclosure;

FIG. 2 is a flow diagram of the video image processing method based on virtual reality in Embodiment 1;

FIG. 3 is a structure diagram of the video image processing device based on virtual reality in the embodiment of the disclosure;

FIG. 4 is a structure diagram of the synthesis module in the embodiment of the disclosure; and

FIG. 5 is a structure block diagram of the video image processing electronic device based on virtual reality in the embodiment of the disclosure.

### DETAILED DESCRIPTION

Hereinafter, with reference to the accompanying drawings, the specific embodiments of the disclosure are described in details, and it will be appreciated that the protection scope of the disclosure is not limited by the specific embodiments.

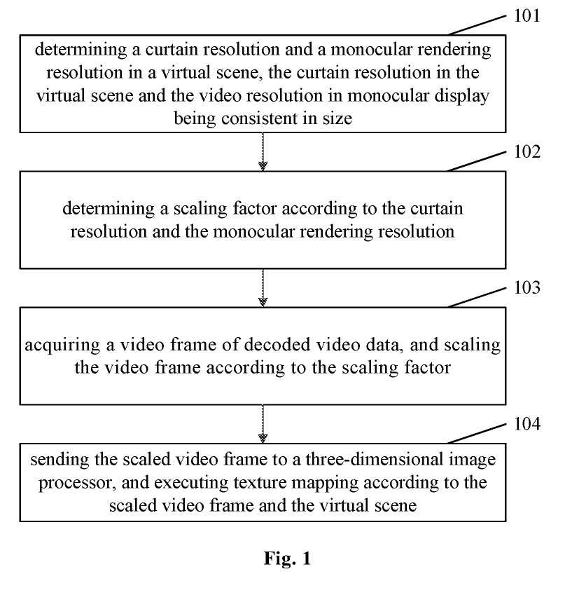

According to the embodiments of the disclosure, a video image processing method based on virtual reality is provided. FIG. 1 is a flow diagram of the method. The method specifically comprises steps 101-104:

S101 includes determining a curtain resolution and a monocular rendering resolution in a virtual scene, the curtain resolution in the virtual scene and the video resolution in monocular display being consistent in size.

In the embodiment of the disclosure, a curtain is arranged at a preset position in a virtual scene (generally arranged in the center of the virtual scene), and is used for placing video resources; and a virtualized scene is around the curtain. For example, if the virtual scene is a cinema, the curtain is a screen for playing a movie, and chairs and the like are arranged around the curtain when people watch a movie from the angle of a viewer. The monocular rendering resolution is a monocular display range, namely the entire scene that a viewer can watch, and the display range of the left eye is the same as that of the right eye. The curtain resolution is the size of a curtain in the virtual scene, and the curtain is used for displaying a video in monocular display, so that the curtain resolution in the virtual scene and the video resolution in the monocular display are consistent in size.

S102 includes determining a scaling factor according to the curtain resolution and the monocular rendering resolution.

In the embodiment of the disclosure, a scaling factor is determined according to the curtain resolution and the monocular rendering resolution, so that a video frame can be scaled according to the scaling factor. For example, if the monocular rendering resolution is 960×1080 and the curtain resolution is 480×540, so the scaling factor is ¼, that is to say, when the video frame is scaled, the video frame is scaled to be ¼ of the original size.

Optionally, the monocular rendering resolution is the same as the screen resolution; and the screen resolution is specifically a video resolution. The scaled video frame can be obtained according to the scaling factor and an initial video frame.

S103 includes acquiring a video frame of decoded video data, and scaling the video frame according to the scaling factor.

In the embodiment of the disclosure, the video frame is directly scaled after decoding, specifically, the video frame can be scaled according to the scaling factor by virtue of a two-dimensional image processor and/or a decoder rather than a three-dimensional image processor GUP, therefore, the three-dimensional image processing resources can be saved.

S104 includes sending the scaled video frame to a three-dimensional image processor, and executing texture mapping according to the scaled video frame and the virtual scene.

Specifically, executing texture mapping according to the scaled video frame and the virtual scene in S104 comprises steps A1-A2:

step A1 includes synthesizing the scaled video frame and the corresponding virtual scene, and placing the scaled video frame to a corresponding position in the virtual scene as a texture; and

step A2 includes pushing a synthesized rendering video to a display screen. That is to say, a three-dimensional virtual space scene and a mapped video are transmitted together to a screen for displaying, and the screen resolution of the screen is the same as the monocular rendering resolution.

For the video image processing method based on virtual reality, provided by the embodiment of the disclosure, a professional two-dimensional image engine preset in a chip of a chip plant is used by the method to scale the video frame at first after decoding, and then the scaled video frame is transmitted to a three-dimensional image processor for displaying as a texture, so that the purpose of saving three-dimensional graphic processing resources is achieved.

Optionally, when the format of the video frame of the decoded video data is YUV, scaling the video frame according to the scaling factor comprises steps B1-B2:

step B1 includes converting the video frame with a YUV format into a video frame with an RGB format; and

step B2 includes scaling the video frame with the RGB format according to the scaling factor.

Hereinafter, the flow diagram of the method is introduced in details through an embodiment.

### Embodiment 1

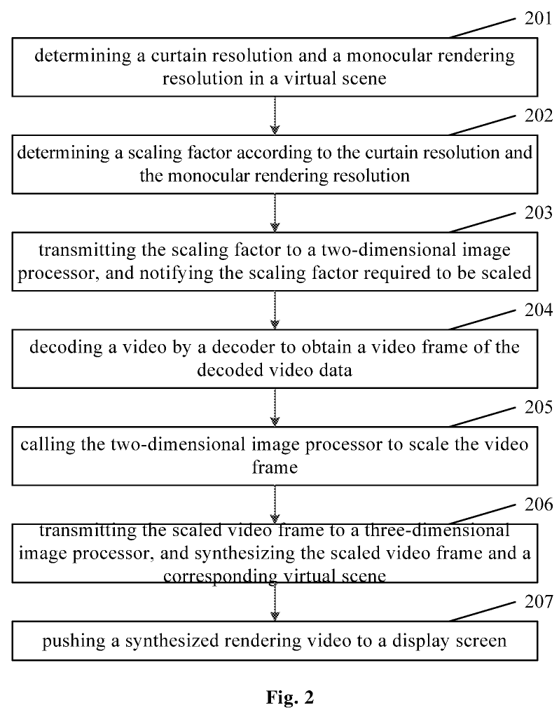

In embodiment 1, the monocular rendering resolution is the same as the screen resolution, and the video image processing method based on virtual reality, provided by embodiment 1, as shown in FIG. 2, comprises steps 201-207:

S201 includes determining a curtain resolution and a monocular rendering resolution in a virtual scene;

S202 includes determining a scaling factor according to the curtain resolution and the monocular rendering resolution;

S203 includes transmitting the scaling factor to a two-dimensional image processor, and notifying the scaling factor required to be scaled;

S204 includes decoding a video by a decoder to obtain a video frame of the decoded video data;

S205 includes calling the two-dimensional image processor to scale the video frame;

S206 includes transmitting the scaled video frame to a three-dimensional image processor, and synthesizing the scaled video frame and a corresponding virtual scene,

wherein the scaled video frame is placed to a corresponding position in the virtual scene as a texture; and

S207 includes pushing a synthesized rendering video to a display screen.

For the video image processing method based on virtual reality, provided by the embodiments of the disclosure, a professional two-dimensional image engine preset in a chip of a chip plant is used by the method to scale the video frame at first after decoding, and then the scaled video frame is transmitted to a three-dimensional image processor for displaying as a texture, so that the purpose of saving three-dimensional graphic processing resources is achieved. When the format of the video frame of the decoded video data is YUV, the video frame is continuously converted into an RGB format through two-dimensional image processing, thereby further saving the three-dimensional graphic processing resources.

The flow of the video image processing method based on virtual reality is introduced in details above. The method can also be realized by a corresponding device. The structure and functions of the device are introduced in details below.

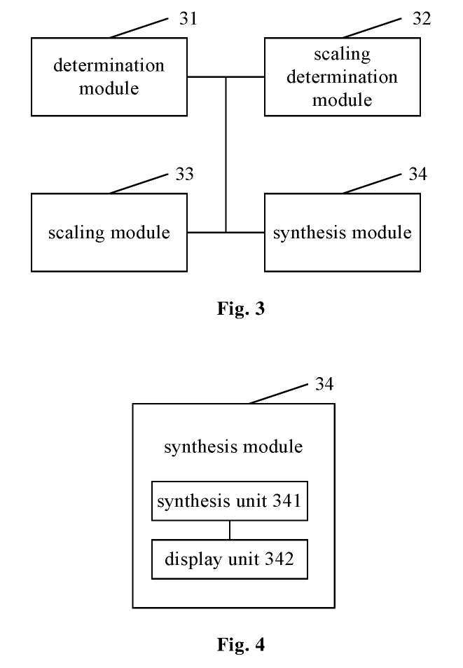

According to the embodiment of the disclosure, a video image processing device based on virtual reality is provided. As shown in FIG. 3, the device comprises: a determination module 31, a scaling determination module 32, a scaling module 33 and a synthesis module 34.

The determination module 31 is used for determining a curtain resolution and a monocular rendering resolution in a virtual scene, the curtain resolution in the virtual scene and the video resolution in monocular display being consistent in size;

The scaling determination module 32 is used for determining a scaling factor according to the curtain resolution and the monocular rendering resolution;

The scaling module 33 is used for acquiring a video frame of decoded video data, and scaling the video frame according to the scaling factor; and

The synthesis module 34 is used for sending the scaled video frame to a three-dimensional image processor, and executing texture mapping according to the scaled video frame and the virtual scene.

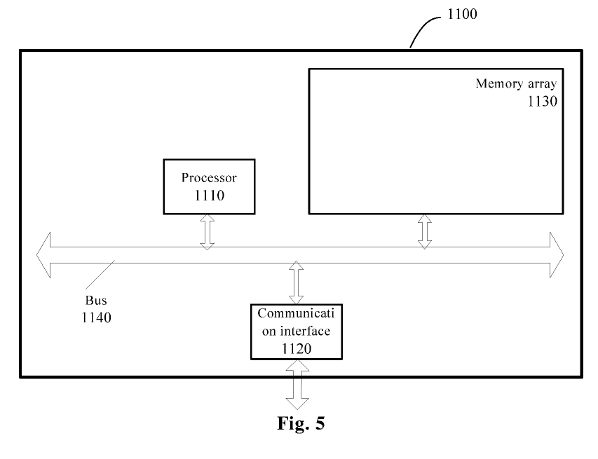

Optionally, as shown in FIG. 4, the synthesis module 34 comprises:

a synthesis unit 341, used for synthesizing the scaled video frame and the corresponding virtual scene, and placing the scaled video frame to a corresponding position in the virtual scene as a texture; and

a display unit 342, used for pushing a synthesized rendering video to a display screen.

Optionally, when the format of the video frame of the decoded video data is YUV, the scaling module 33 is also used for:

converting the video frame with a YUV format into a video frame with an RGB format; and scaling the video frame with the RGB format according to the scaling factor.

Optionally, the scaling module 33 is specifically used for:

calling a two-dimensional image processor and/or decoder to scale the video frame according to the scaling factor.

Optionally, the monocular rendering resolution is the same as the screen resolution.

For the video image processing method and device based on virtual reality, provided by the embodiments of the disclosure, a professional two-dimensional image engine preset in a chip of a chip plant is used by the method to scale the video frame at first after decoding, and then the scaled video frame is transmitted to a three-dimensional image processor for displaying as a texture, so that the purpose of saving three-dimensional graphic processing resources is achieved. When the format of the video frame of the decoded video data is YUV, the video frame is continuously converted into an RGB format through two-dimensional image processing, thereby further saving the three-dimensional graphic processing resources.

According to the embodiment of the disclosure, a non-transitory computer-readable storage medium is provided, and the non-transitory computer-readable storage medium stores executable instructions that, when executed by an electronic device, cause the electronic device to executing the video image processing method based on the virtual reality technology provided by the above embodiments of the disclosure.

FIG. 5 is a schematic diagram of the hardware structure of electronic device executing the video image processing method based on the virtual reality, provided by an embodiment of the disclosure. As shown in FIG. 5, the device comprises one or more processors 1110 and a memory 1120. A case of one processor 1110 is taken as an example in FIG. 5.

The device executing the video image processing method based on the virtual reality further comprises an input device 1130 and an output device 1140.

The processor 1110, the memory 1120, the input device 1130 and the output device 1140 may be connected through a bus or in other ways. A case of bus connection is taken as an example in FIG. 5.

As a non-transitory computer-readable storage medium, the memory 1120 can be used for storing non-transitory software programs, non-transitory computer executable programs and modules, such as program instructions/modules (i.e., the determination module 31, the scaling determination module 32, the scaling module 33 and the synthesis module 34 as shown in FIG. 3) corresponding to the video image processing method based on the virtual reality described in the embodiment of the disclosure.

The memory 1120 further comprises a program storage area and a data storage area, wherein the program storage area can store an operating system or application programs required by at least one function, and the data storage area can store data, etc., created according to using of the video image processing device based on the virtual reality. In addition, the memory 1120 may include a high speed random access memory and further may include a non-transitory memory, such as at least one disk memory, a flash memory, or other non-transitory solid-state memories. In some embodiments, the storage 1120 optionally include memories set up remotely relative to the processor 1110, and these remote memories can be connected to the video image processing device based on the virtual reality through a network. The above-mentioned networks include but are not limited to the Internet, Intranet, LAN, mobile communication networks and a combination thereof.

The input device 1130 can receive input figure or character information and generate key signal inputs in connection with user settings and function control of the video image processing device based on the virtual reality. The output device 1140 may include display devices such as a display screen.

The one or more modules are stored in the memory 1120 and are used for executing the video image processing method based on the virtual reality disclosed in any of the above-mentioned method embodiments when executed by one or more processors 1110.

The above-mentioned product can execute the method provided by the embodiments of the disclosure and has corresponding functional modules executing the method and beneficial effects. The technical details not described in the embodiment in detail are available with reference to the method provided by the embodiments of the disclosure.

The electronic device in the embodiments of the disclosure exists in many forms, including but not limited to:

Mobile communication equipment: this type of device is featured with a mobile communication function, and is mainly used for providing voice and data communication. These terminals include: a smartphone (e.g. iPhone), a multimedia phone, a functionality phone, and a low-end phone, and the like.

Ultra mobile personal computer equipment: this type of equipment belongs to the range of personal computers, and is provided with computation and processing functions, and typically has a mobile internet characteristic. These terminals include: PDA, MID and UMPC equipment, and the like, such as iPad.

Portable recreation equipment: this type of equipment can display and play multimedia contents. This type of equipment include: voice and audio players (such as iPod), handheld game players, e-books, intelligent toys and portable vehicle navigation equipment.

Servers: apparatus can provide computing service, and servers include: processors, hard disks, memories, system buses and the like, architecture of the servers is similar to that of a general-purpose computer, however, due to requirement for providing high-quality and reliable service, the requirements on processing capability, stability, reliability, safety, expandability, manageability and other aspects are higher.

Other electronic devices with a data interaction function.

The device embodiments described above are merely exemplary, wherein units described as separated components can be or cannot be separated physically, components displayed as units can be or cannot be physical units, namely can be located in one place, or can be distributed on multiple network units. The object of the solution of the embodiments can be achieved by selecting part or all of modules according to practical demands.

Based on the above description of the embodiments, it can be clearly appreciated by person skilled in the art that the embodiments can be implemented in a way of combination of software and a universal hardware platform or through hardware certainly. Based on such understanding, the nature of the above-mentioned technical solution or its part making contribution to relevant technology can be embodied in form of software. The computer software product can be stored in a computer-readable storage medium, such as ROM/RAM, a disk, CD, etc. and comprises a plurality of instructions for enabling one set of computer equipment (which may be a personal computer, a server or network equipment, etc.) to execute the method described in all embodiments or in part of an embodiment.

Finally, it should be noted that the above-mentioned embodiments are only used for explaining the technical solution of this application but not for limiting it. Even though this application has been described in detail with reference to the aforesaid embodiments, it should be understood that person skilled in the art still can modify the technical solutions disclosed in the above-mentioned embodiments or make equivalent substitutions to part of technical features; and these modifications or substitutions will not depart the corresponding technical solutions essentially from the spirit and scope of the technical solutions of all embodiments of this application.

1. A video image processing method based on virtual reality, executed by a terminal, comprising:
determining a curtain resolution and a monocular rendering resolution in a virtual scene, the curtain resolution in the virtual scene and the video resolution in monocular display being consistent in size;
determining a scaling factor according to the curtain resolution and the monocular rendering resolution;
acquiring a video frame of decoded video data, and scaling the video frame according to the scaling factor; and
sending the scaled video frame to a three-dimensional image processor, and executing texture mapping according to the scaled video frame and the virtual scene.

2. The method according to claim 1, wherein executing texture mapping according to the scaled video frame and the virtual scene comprises:
synthesizing the scaled video frame and the corresponding virtual scene, and placing the scaled video frame to a corresponding position in the virtual scene as a texture; and
pushing a synthesized rendering video to a display screen.

3. The method according to claim 1, wherein when the format of video frame of the decoded video data is YUV, scaling the video frame according to the scaling factor comprises:
converting the video frame with a YUV format into a video frame with an RGB format; and
scaling the video frame with the RGB format according to the scaling factor.

4. The method according to claim 1, wherein scaling the video frame according to the scaling factor comprises:
calling a two-dimensional image processor and/or decoder to scale the video frame according to the scaling factor.

5. The method according to claim 1, wherein the monocular rendering resolution is the same as a screen resolution.

6. A non-transitory computer-readable storage medium storing executable instructions that, when executed by an electronic device, cause the electronic device to:
determine a curtain resolution and a monocular rendering resolution in a virtual scene, the curtain resolution in the virtual scene and the video resolution in monocular display being consistent in size;
determine a scaling factor according to the curtain resolution and the monocular rendering resolution;
acquire a video frame of decoded video data, and scale the video frame according to the scaling factor; and
send the scaled video frame to a three-dimensional image processor, and execute texture mapping according to the scaled video frame and the virtual scene.

7. The non-transitory computer-readable storage medium according to claim 6, wherein the step to execute texture mapping according to the scaled video frame and the virtual scene comprises:
synthesize the scaled video frame and the corresponding virtual scene, and place the scaled video frame to a corresponding position in the virtual scene as a texture; and
push a synthesized rendering video to a display screen.

8. The non-transitory computer-readable storage medium according to claim 6, wherein when the format of video frame of the decoded video data is YUV, the step to scale the video frame according to the scaling factor comprises:
convert the video frame with a YUV format into a video frame with an RGB format; and
scale the video frame with the RGB format according to the scaling factor.

9. The non-transitory computer-readable storage medium according to claim 6, wherein the step to scale the video frame according to the scaling factor comprises:
call a two-dimensional image processor and/or decoder to scale the video frame according to the scaling factor.

10. The non-transitory computer-readable storage medium according to claim 6, wherein the monocular rendering resolution is the same as a screen resolution.

11. An electronic device, comprising:
at least one processor; and
a memory communicably connected with the at least one processor for storing instructions executable by the at least one processor, wherein execution of the instructions by the at least one processor causes the at least one processor to:
determine a curtain resolution and a monocular rendering resolution in a virtual scene, the curtain resolution in the virtual scene and the video resolution in monocular display being consistent in size;
determine a scaling factor according to the curtain resolution and the monocular rendering resolution;
acquire a video frame of decoded video data, and scale the video frame according to the scaling factor; and
send the scaled video frame to a three-dimensional image processor, and execute texture mapping according to the scaled video frame and the virtual scene.

12. The electronic device according to claim 11, wherein the step to execute texture mapping according to the scaled video frame and the virtual scene comprises:
synthesize the scaled video frame and the corresponding virtual scene, and place the scaled video frame to a corresponding position in the virtual scene as a texture; and
push a synthesized rendering video to a display screen.

13. The electronic device according to claim 11, wherein when the format of video frame of the decoded video data is YUV, the step to scale the video frame according to the scaling factor comprises:
convert the video frame with a YUV format into a video frame with an RGB format; and
scale the video frame with the RGB format according to the scaling factor.

14. The electronic device according to claim 11, wherein the step to scale the video frame according to the scaling factor comprises:
call a two-dimensional image processor and/or decoder to scale the video frame according to the scaling factor.

15. The electronic device according to claim 11, wherein the monocular rendering resolution is the same as a screen resolution.
